(19) United States
(12) Patent Application Publication
(10) Pub. No.: US 2003/0070623 A1
(43) Pub. Date: Apr. 17, 2003

(54) Bio-degradable pet litter made from coconut coir

(76) Inventor: Malcolm MacQuoid, Park City, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/268,122

(22) Filed: Oct. 10, 2002

Related U.S. Application Data
(60) Provisional application No. 60/329,658, filed on Oct. 16, 2001.

(51) Int. Cl. A01K 29/00

(52) U.S. Cl. 119/171

(57) ABSTRACT

A new use of coconut coir includes using the coir as an absorbent in pet litter. The coconut coir can be used alone as a kitty litter or other pet litter, in combination with fragrance, or in combination with other absorbents such as clay, gypsum, diatomaceous earth, alfalfa, wood chips, sawdust, paper, foam, plastic or other similar absorbent material.

### BACKGROUND OF THE INVENTION

1. Related Applications

The present application claims the benefit of U.S. Provisional Patent Application No. 60/329,658, filed on Oct. 16, 2001.

2. Field of the Invention

This invention relates to a disposable and biodegradable pet litter. More particularly, the present invention relates to a disposable pet litter made from coconut coir.

3. State of the Art

Because cats can be left alone indoors for extended periods of time, many people, especially those in urban environments or those who work away from the home all day, keep cats as pets. Likewise, many people keep other pets, such as hamsters, gerbils, ferrets and the like which can be left alone for extended periods of time.

Often, the period of time the cat or other pet is alone in the house is 10 to 12 hours each day, due to the time required for full time employment and travel to and from the workplace. This creates the need for a convenient short term accommodation of animal waste products for confined and unattended pets. The material used for this accommodation of animal waste should preferably be made of an absorbent material that can be disposed of along with the animal waste.

The typical solution to this need is the device commonly known as the litter box. A litter box is generally a shallow open container containing an absorbent material such as clay, gypsum, diatomaceous earth, alfalfa, wood chips, sawdust, paper, foam, or even plastic. For some animals, such as hamsters, etc., the litter box is essentially the living surface of the animal.

The upkeep of a litter box is crucial to the comfort of a pet and/or enjoyment of a pet by its owner. Specifically, the pet will interact with the litter box while relieving itself. After a period of time, however, the litter will reach a sanitarily unacceptable condition. At this point, the litter must be changed. Otherwise, the pet may reject the litter box and instead seek alternate locations, such as rugs, floors, furniture, and plants, on which to relieve itself. For animals which essentially live in their own litter box, keeping the litter clean is a major environmental factor for the animal. Additionally, the sanitarily unacceptable litter will often produce an undesirable odor and may be of a non-hygienic nature and unpleasant for both the animal and the owner. Consequently, a pet owner must be extremely conscientious about replacing the litter on a timely basis.

The frequency with which kitty litter must be changed is a direct function of the absorbency of the litter and its ability to suppress odors. The less absorbent the litter, the more often it must be changed. Many of the materials used for litter are not as absorbent as one might like, necessitating the frequent changing and disposal of the litter.

A pet litter that is more absorbent than traditional kitty litters helps to alleviate the problem of cleanliness by reducing the frequency with which the litter needs to be changed. In addition, unless they have been chemically treated, many traditional litters have little ability to suppress the odors associated with animal waste. A litter that has the ability to suppress odors associated with animal waste would also help to decrease the frequency with which the litter needs to be changed.

Many traditional kitty litters are also generally not bio-degradable and create a disposal problem. In addition, because they generally must be manufactured from clay or other minerals, traditional kitty litters are relatively expensive and may contain chemical residues that result from processing. These residues can be irritating both to the cat and to the cat's owner. Furthermore, these residues can be tracked around the house, leaving undesirable deposits.

Additionally, many products used as kitty litter, especially those clay based kitty litters, tend to generate a great deal of dust. This dust, which often contains large amounts of silica, can be irritating to the eyes and throat of pet owners. The silica dust can also present a health hazzard to those who breathe it in in large amounts. Many products which are similar to kitty litter carry safety warnings advising people to avoid breathing the dust and to use only in well ventilated areas. As a cat uses the litter box, the silica dust in the kitty litter is continually kicked up—permeating the air in the house. Particular problems can be raised for a cat which frequently licks its paws. The moist paws are more likely to retain large amounts of dust and residues when the cat uses the litter box, and the cat is likely to ingest the dust, which is believed to be potentially carcinogenic, the next time it licks its paws.

Additionally, the dust often sticks to the paws of cat and is tracked around the house. Thus, the cat's owner is required to constantly clean the house. If the silica dust is not frequently removed, it can build up, both making the house appear unclean and acting as an irritant.

The present invention is superior to traditional kitty litters and litters used for other pets in the above respects. It is more absorbent than traditional kitty litters, and other pet litters, and has natural odor suppressing ability. Hence, it needs to be changed less frequently. It is also lower in cost than most and is one hundred percent (100%) bio-degradable. Because it is not usually a chemically processed material, it does not contain chemical residues that might result from processing, and that might cause allergic reactions or exacerbate hay fever and the like. Finally, because it is a fibrous organic material, it does not produce dust like clay based kitty litters.

### SUMMARY OF THE INVENTION.

It is an object of the present invention to make a pet litter from natural, biodegradable material.

The present invention involves using coconut coir as a material for pet litter. Coconut coir is the fibers of the the coconut husk which remains after the coconut has been processed. After the edible portion of the coconut is separated from the shell, the shell, along with the husk, remains. The husk of a coconut is comprised of many fibers which range in size from very long to relatively short. The longer coconut fibers are processed into a coarse cloth material for use in such items as burlap. After the longer fibers are processed, the relatively short fibers, which are highly absorbent, remain.

In accordance with one aspect of the present invention, the coconut coir dust is packaged in a conventional container, such as a plastic bag or bucket. When a litter box needs to be changed, the contents of the litter box are disposed in a conventional manner. The litter box is then filled with coconut coir by pouring the coir out of the container. The coconut coir quickly absorbs any liquid associated with the animal waste and can be easily moved about to cover feces. Additionally, no silica dust is released during use by the cat.

In accordance with another aspect of the invention, the coconut coir is formed into pellets or pellet fragments. The pellets or pellet fragments are used in the litter box and minimize any tendency for the coconut coir to be scattered by the cat. As the pellets or pellet fragments absorb liquids, the coconut coir tends to remain clumped together, minimizing spills of the coir outside the box.

In accordance with another aspect of the invention, the coconut coir is combined with other materials. Such materials can include other conventional litter materials, such as clay, gypsum, diatomaceous earth, alfalfa, wood chips, sawdust, paper, foam, or even plastic. Additionally, the coconut coir can be mixed with odor suppressing agents, such as fragrances, and with deodorants, such as baking soda, etc. The mixture can be in a powder like form with the coconut coir dust, or may be formed as part of the coconut coir pellets. It is preferred that the coconut coir be at least 40 percent of the mixture. It is more preferred that the coconut coir be at least 50 percent of the mixture, and most preferred that the coconut coir be at least 60 percent of the mixture by volume.

### BRIEF DESCRIPTION OF THE DRAWINGS

The above and other objects, features and advantages of the invention will become apparent from a consideration of the following detailed description presented in connection with the accompanying drawings in which:

FIG. 1 shows a side view of a litter box having bio-degradable pet litter disposed therein in accordance with the principles of the present invention; and

FIG. 2 shows a top view of a litter box having kitty litter pellets disposed therein in accordance with the principles of the present invention.

### DETAILED DESCRIPTION

Reference will now be made to the drawings in which the various elements of the present invention are discussed in a manner to enable one of skill in the art to make and use the invention. It is to be understood that the following description is only exemplary of the principles of the present invention and should not be viewed as limiting the appended claims

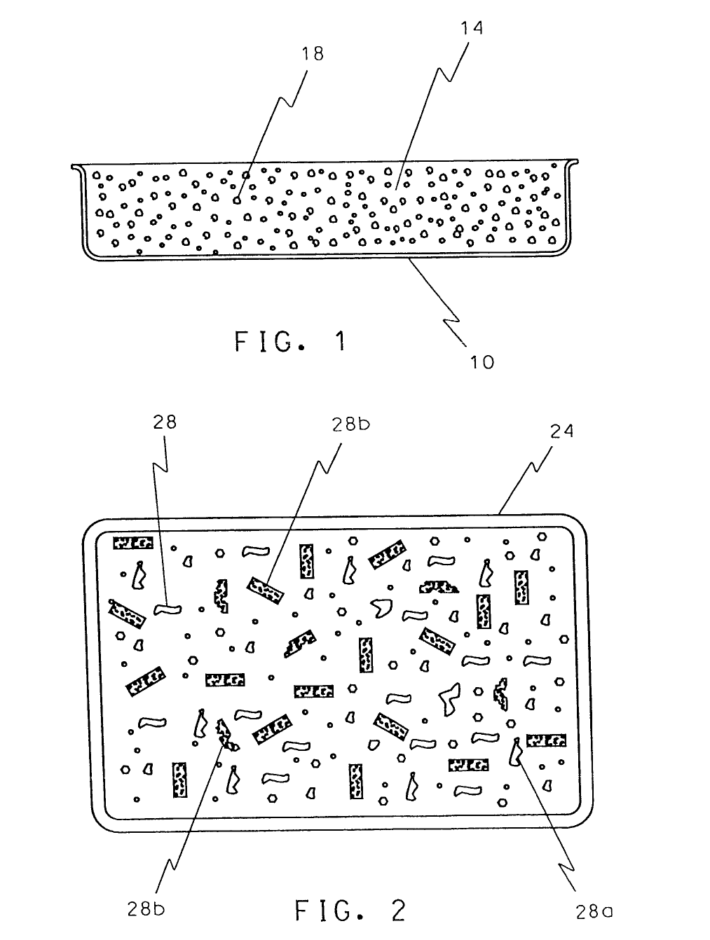

Referring now to FIG. 1, there is shown a side view of a litter box, generally indicated at 10, which is filled with a pet litter 14 made in accordance with the principles of the present invention. The pet litter 14 is made from coconut coir 18, and preferably from that portion of the coir having most of the long fibers removed so that the coir is generally of the consistency of relatively small grains.

The coconut coir 18 may be the only component of the pet litter, or the coconut coir may be mixed with other materials if desired. Materials which are common in pet litter and which may be combined with the coconut coir 18 include clay, gypsum, diatomaceous earth, alfalfa, wood chips, sawdust, paper, foam and plastic.

Whether used as the exclusive ingredient or as part of a mixture, the coconut coir is advantageous for several reasons. First, the use of coconut coir 18 is environmentally advantageous. Traditionally produced as a by-product of processing coconuts, the tremendous volume of coconut coir that is produced each year presents a disposal problem to coconut processors. The coconut coir is generally left in large piles near the location where the coconuts are processed. Piles of discarded coconut coir present a fertile habitat and breeding ground for species of beetles which are harmful to coconut trees. Thus, by providing a use for the coconut coir, the environmental impacts traditionally associated with coconut coir are reduced or eliminated. While coconut coir is used in agriculture, using the coir in pet products may generate more income from the by-product and thereby make coconut processing more profitable.

Furthermore, coconut coir is extremely absorbent and is biodegradable. Coconut coir can absorb up to 9 times its own weight in liquid. Thus, it is an excellent material to use as kitty litter and for other pet litters. Furthermore, it has been found to be relatively good at suppressing odors associated with animal waste.

Kitty litter made of coconut coir is less expensive to manufacture than traditional kitty litter products. Coconut coir is processed into the form needed for kitty litter as a natural result of processing coconuts. Thus, it needs little or no further processing. Because traditional kitty litters are manufactured by processing minerals such as clay or organic materials such as paper, the cost of this processing is reflected in the cost of the kitty litter. Additionally, the clays and other minerals often used for kitty litter are often mined. The mining process can cause considerable environmental impact. Because of the large supply of coconut coir that is produced during the processing of coconuts, coconut coir can be obtained at a relatively low cost. The largest cost associated with obtaining coconut coir is the cost of shipping it from the coconut processing location to the market. Thus, coconut coir is generally much cheaper than traditional forms of kitty litter. Furthermore, the coconut coir is a renewable resource and is much less likely to cause environmental impacts.

Using coconut coir as kitty litter and other pet litters also helps the environment by minimizing landfill disposals. Because the coconut coir is biodegradable, the litter box my be emptied into flower beds, gardens and the like. The mixture of coconut coir and animal waste forms a beneficial soil conditioner.

The litter 14 formed in accordance with the present invention is also more absorbent than traditional kitty litters, and other types of pet litters. The frequency with which kitty litter must be changed is a direct function of the absorbency of the material used as litter. Traditional kitty litters are not particularly absorbent and therefore must be changed fairly frequently. Likewise, sawdust and wood chips often used for other pet litters are only mildly absorbent. Coconut coir, in contrast, is extremely absorbent, being able to absorb up to 9 times its weight in liquids. Thus, it does not need to be changed as frequently as traditional kitty litters or other pet litters.

Another drawback to traditional litters is that many have little or no ability to neutralize the odor that accompanies animal waste. Coconut coir, in contrast, has the ability to control and minimize odors associated with animal waste. This ability to control and minimize odors associated with animal waste also helps eliminate the need to change the kitty litter as often as is the case with traditional kitty litters.

The present invention is also superior to traditional kitty litters in that it involves little or no chemical processing. Traditional kitty litters are made from processing minerals such as clay or from processing paper products. Thus traditional kitty litter products have a tendency to contain chemical residues or silica dust that are the result of the processing. Coconut coir, by contrast, is a natural waste product of the processing of coconuts. Coconut processing is a mechanical rather than a chemical process. In its discarded form, coconut coir is suitable for use as pet litter and needs not little, if any, further processing. Thus, it contains no chemical residues that might result from processing and which might irritate a pet. Furthermore, there is no silica dust, which may harm pets who ingest large quantities—such as by licking their paws.

Coconut Coir is also superior to traditional kitty litters in that it is one hundred percent (100%) natural and biodegradable. Because coconut coir is an organic product as opposed to being a processed mineral, it is completely bio-degradable. Thus, coconut coir based pet litter is generally more environmentally friendly and does not present the disposal problem that other mineral based kitty litter products present.

Finally, the use of coconut coir as kitty litter does not create the dust problem that is associated with many other kitty litters. Many traditional kitty litters are comprised of clay or clay mixed with an organic substance. When they are being used, especially when they are poured, these clay based kitty litters tend to generate a great deal of dust. Coconut coir is a fibrous organic material. As such, it does not generate much dust, even when it is being poured into the cat box.

While the use of coconut coir exclusively as the pet litter is presently preferred, it is within the scope of the present invention to use coconut coir pet litter is association with other materials. For example using a combination of coconut coir and clay for a kitty litter would still reduce the amount of silica dust generated from the kitty litter, and would provide some environmental benefit as set forth above. Likewise a combination of coconut coir and wood shavings may be used for a hamster cage, etc. It is presently preferred that the coconut coir be at least 40 percent of the mixture. It is even more preferred to have the coconut coir be at least 50 percent of the mixture and even more preferable to have the coconut coir be at least 60 percent of the mixture.

The mixture can include coconut coir and a single element, or could include two or more of the group including clay, gypsum, diatomaceous earth, alfalfa, wood chips, wood shavings, sawdust, foam, plastic and paper. Some of these materials may be provided so that the pet litter including coconut coir still has a somewhat familiar smell and touch to the cat or other pet.

While using the coconut coir 18 to form pet litter with grain like consistency is desirable, it is also desirable to form the coconut coir into pellets. As shown in FIG. 2, there is a top view of a litter box 24. Disposed in the litter box 24 are a plurality of pellets 28. The pellets may be formed from coconut coir exclusively, as shown with pellets 28a or may be formed from a combination of coconut coir and other materials as shown with pellets 28b.

The pellets 28 can be formed in a number of ways. Presently there are numerous commercially available machines which are used to create feed pellets for animals. Such machines typically compress small granules of grains or other materials—often in the presence of steam or binding agents—to form small pellets. These same machines can be used to form pellets of coconut coir or a mixture of coconut coir and materials such as clay, gypsum, diatomaceous earth, alfalfa, wood chips, sawdust, paper, foam, plastic.

The use of pellets 28 has several advantages. The use of pellets minimizes the amount of coconut coir dust which might be tracked around by the cat or other pet. As liquid is added to the pellets, the coconut coir tends to stay bunched together. This further reduces the risk that the cat will track the coconut coir around the house. Additionally, it makes it easier for the cats owner to scoop used coconut coir out of the litter box 24 is desired. Finally, the formation of a pellet with coconut coir and materials such as clay or gypsum reduces the amount of mineral dust which is likely to be generated, as the surface area of the mineral granule along which the dust can be developed and released is reduced.

The size of the pellet is generally not critical, but is of some importance. Because many cat cover their waste, it is preferable that the pellets not be overly large. In contrast, it is also desirable to have the pellets not be too small, as the ability of the coconut coir to clump together and avoid being tracked around the house is somewhat dependant on size. Thus, it is preferred that the pellets be between about 1/16th of an inch and 1 inch in length.

In early tests with cats, it has been found that a preferred method for forming the litter is to form pellets which are between 1/2 inch and 1 inch long, and about 3/16 to ¼ of an inch in diameter. The pellets are then passed through a crumbler which brakes the pellets into irregular clumps which are about ⅛ to ¼ of an inch in diameter. In such a size, the crumbled pellets have a feel similar to that of conventional kitty litter. They are large enough, however, to remain clumped together when wetted, and to avoid being tracked around the house by the cat. Of course, while cylindrical pellets have been used to make the crumbled pellets, other shapes of pellets can also be used. Additionally pellets of different dimensions may be used for different types of pets.

While adding absorbent materials as discussed above can be beneficial in some circumstance, the coconut coir can also be mixed with other additives. For example, the coconut coir can be treated directly with fragrance, or cam be mixed with granules which release fragrance when contacted by the cat. In such a manner, the odor absorbing ability of the coconut coir is further enhanced, and a pleasant aroma is released to further mask the smell of the animal waste.

Thus, there is disclosed an improved kitty litter formed from coconut coir. Those skilled in the art will appreciate numerous modifications which can be made without departing from the scope and spirit of the present invention. The appended claims are intended to cover such modifications.

What is claimed is:

1. A temporary receptacle for animal waste comprising:
a litter box; and
processed coconut husks.

2. The temporary receptacle according to claim 1 wherein the processed coconut husks comprise coconut coir.

3. The temporary receptacle according to claim 2, wherein the coconut coir is mixed with at least one of the group consisting of clay, gypsum, diatomaceous earth, alfalfa, wood chips, wood shavings, sawdust, paper, foam and plastic.

4. The temporary receptacle according to claim 3, wherein the mixture is formed into pellets.

5. The temporary receptacle according to claim 4, wherein the mixture is at least 40 percent coconut coir by volume.

6. The temporary receptacle according to claim 5, wherein the mixture is at least 50 percent coconut coir by volume.

7. The temporary receptacle according to claim 1, wherein the processed coconut husks in the temporary receptacle forms kitty litter and wherein the coconut husks are at least 60 percent of the volume of the kitty litter.

8. The temporary receptacle according to claim 2, wherein the coconut coir is formed into pellets.

9. The temporary receptacle according to claim 8, wherein the pellets are less than one inch long.

10. The temporary receptacle according to claim 9, wherein the pellets are crumbled so that the pellets have an average diameter of about ⅛ of an inch.

11. The temporary receptacle according to claim 2, further comprising fragrance added to the coconut coir.

12. The litter box according to claim 11, wherein the coconut coir is mixed with fragrance releasing granules.

13. A method for forming pet litter comprising:
using coconut coir as pet litter.

14. The method according to claim 13, further comprising disposing the coconut coir in a litter box.

15. The method according to claim 14, wherein the method comprises using exclusively coconut coir in the litter box.

16. The method according to claim 13, wherein the method comprises using coconut coir in combination with at least one of the group consisting of clay, gypsum, diatomaceous earth, alfalfa, wood chips, wood shavings, sawdust, paper, foam, plastic or other similar absorbent material.

17. The method according to claim 16, further comprising forming a mixture which is at least 40 percent coconut coir by weight.

18. The method according to claim 16, further comprising forming a mixture which is at least 50 percent coconut coir by weight.

19. The method according to claim 16, further comprising forming a mixture which is at least 60 percent coconut coir by weight.

20. The method according to claim 16, wherein the method comprises forming the combination into a pellet.

21. The method according to claim 13, wherein the method comprises adding fragrance to the coconut coir.

22. The method according to claim 21, wherein the method comprises mixing the coconut coir with fragrance releasing granules.

23. The method according to claim 20, wherein the method further comprises crumbling the pellet.

24. The method according to claim 23, wherein the method comprises crumbling the pellet so that the average diameter of the crumbled pellets is about ⅛ of an inch.

25. A new use for coconut coir, the use comprising using coconut coir as kitty litter.

26. The use according to claim 25, wherein the coconut coir is mixed with at least one material selected from the group consisting of clay, gypsum, diatomaceous earth, alfalfa, wood chips, sawdust, paper, foam, plastic or other similar absorbent material.

27. The use according to claim 25, wherein the mixture of the coconut coir and the at least one absorbent is formed into pellets.

28. The use according to claim 27, wherein the pellets are crumbled.

29. The use according to claim 28, wherein the pellets are crumbled to provide irregular pellets having an average diameter of about ⅛th of an inch.

30. The use according to claim 25, wherein the coconut coir is mixed with fragrance.

31. The use according to claim 25, wherein the use comprises using coconut coir which are been formed into pellets which are between ⅛th of an inch and 1 inch long,

32. A pellet comprising:
coconut coir; and
at least one of the group consisting of clay, gypsum, diatomaceous earth, alfalfa, wood chips, wood shavings, sawdust, paper, foam and plastic.

33. The pellet according to claim 32, further comprising fragrance.

34. The pellet according to claim 32, wherein the pellet is at least 40 percent coconut coir.

35. The pellet according to claim 34, wherein the pellet is at least 50 percent coconut coir.

36. The pellet according to claim 35, wherein the pellet is at least 40 percent coconut coir.

37. The pellet according to claim 32, wherein the coconut coir is mixed with an absorbent selected from the group consisting of clay, gypsum, diatomaceous earth, alfalfa, wood chips, wood shavings, sawdust, and paper.

38. A plurality of pellets formed in accordance with claim 32, wherein the pellets are crumbled and have an average diameter of about ⅛th of an inch.
